(19) United States
(12) Patent Application Publication
(10) Pub. No.: US 2006/0288202 A1
(43) Pub. Date: Dec. 21, 2006

(54) Method for network restart

(76) Inventors: Mark Doran, Olympia, WA (US); Vincent Zimmer, Federal Way, WA (US); Alan D. Ross, Shingle Springs, CA (US); Michael A. Rothman, Puyallup, WA (US); Gundrala D. Goud, Olympia, WA (US)

Correspondence Address: CARRIE A. BOONE, P.C., 2450 LOUISIANA, SUITE 400-310, HOUSTON, TX, 77006, US

(21) Appl. No.: 11/156,120

(22) Filed: Jun. 17, 2005

(51) Int. Cl. G06F 9/00

(52) U.S. Cl. 713/2

(57) ABSTRACT

A method for restarting a processor-based system is disclosed. The basic input/output system (BIOS) firmware for performing the restart may or may not reside on the processor-based system. Where the local BIOS firmware is corrupt or not present, remote BIOS firmware is loaded into the processor cache by a specialized network interface card. The network interface card includes direct cache access (DCA) functionality, enabling it to store packets retrieved from the network directly into the processor cache, for faster processing. Remote downloading of the BIOS firmware from the network solves on-platform flash corruption within the processor-based system without costly board rework. Other benefits include mitigating the misappropriation of BIOS and chipset intellectual property, improved restart performance of the processor-based system, as well as improvement in chipset validation. Other embodiments are described and claimed.

### FIELD OF THE INVENTION

This invention relates to the restart of a processor-based system and, more particularly, to a method for performing the restart using code retrieved from across a network.

### BACKGROUND OF THE INVENTION

When a processor-based system is first turned on, its system memory, being volatile, is empty. The central processing unit, or CPU, is programmed to immediately execute instructions stored at a predetermined location in a dedicated non-volatile memory. The predetermined location is commonly referred to as the “reset vector.” The non-volatile memory, may be a read-only memory (ROM), such as an EEPROM (electrically-erasable programmable ROM), also known as a flash memory. The instructions programmed into the flash memory are commonly known as the BIOS (short for basic input/output system) firmware.

The BIOS firmware performs pre-operating system functions, such as a power-on self-test (POST), which may include memory test and initialization, executes firmware instructions within device option ROMS, such as in the video and disk drive sub-systems, and conducts an inventory of device hardware connected to the processor-based system. Finally, the BIOS firmware determines the boot device, such as disk drive media, compact disk (CD) ROM, or network, to which the BIOS jumps, passing control to the operating system. Although some BIOS firmware operations have migrated to operating system software in recent implementations, the BIOS firmware still performs initialization sufficient to boot the operating system.

Sometimes, the BIOS firmware in the processor-based system needs to be updated or replaced. The flash memory storing the firmware may become corrupted. Or, a modification to the chipset configuration within the processor-based system may occur. A new feature or enhancement to an existing device within the processor-based system may be desired. Any of these circumstances may necessitate a BIOS or other firmware update.

Updates to the BIOS firmware in the processor-based system, however, may be problematic. Older ROMs may be replaced by physically removing the flash memory chip from the motherboard and inserting a replacement chip which has been programmed with updated firmware. Flash memory devices may be re-programmed using software running on the processor-based system, but only if the software is executable thereon. (Some flash devices include an uncorruptable “boot block” portion, for this purpose.) Despite the programmability of the flash memory device, neither of these solutions generally takes place in the field. Instead, a mere BIOS firmware problem is often solved by returning the motherboard of the processor-based system to the manufacturer, which is costly and frustrating for the consumer and manufacturer alike.

Increasingly, processor-based systems may be powered on using firmware stored in media other than ROM or flash devices. The BIOS firmware may be stored on a partition on a hard disk drive or compact disk (CD) ROM, for example. One example of this mechanism is described in U.S. patent application Ser. No. 10/746,754, entitled, METHOD TO QUALIFY ACCESS TO A BLOCK STORAGE DEVICE VIA AUGMENTATION OF THE DEVICE'S CONTROLLER AND FIRMWARE FLOW, filed on Dec. 24, 2003 by Intel Corporation, assignee of this application.

Some server configurations exist in which multiple processors and chipsets on multiple motherboards are housed in a single frame. These systems may be shipped to customers without hard drives, video cards, displays, keyboards, or mice. Eliminating the costly flash ROMs from each motherboard may likewise be desirable in these specialized server configurations.

Thus, there is a continuing need to improve the performance of the power-on of the processor-based system.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views, unless otherwise specified.

FIG. 1 is a block diagram of a processor-based system, according to the prior art;

FIG. 2 is a block diagram of a processor-based system for performing network-based restart, according to one embodiment;

FIG. 3 is a flow diagram of the process of performing a restart of the processor-based system of FIG. 2, according to one embodiment;

FIG. 4 is a block diagram of a second processor-based system for performing network-based restart, according to one embodiment;

FIG. 5 is a flow diagram of the process for performing a restart of the processor-based system of FIG. 4, according to one embodiment;

FIG. 6 is a block diagram of a system comprising multiple processor-based systems for performing network-based restart, according to one embodiment; and

FIG. 7 is a block diagram of a system including multiple processors for performing network-based restart, according to one embodiment.

### DETAILED DESCRIPTION

In accordance with the embodiments described herein, a method for restarting a processor-based system is disclosed. The BIOS firmware for performing the restart may or may not reside on the processor-based system. Where the local BIOS firmware is corrupt or not present, remote BIOS firmware is loaded into the processor cache by a direct cache access-capable NIC. Remote access to the BIOS firmware facilitates resolution of on-platform flash corruption within the processor-based system without costly board rework. For specialized configurations using remote download of BIOS firmware, the intellectual property of the BIOS firmware and chipset are less vulnerable to misappropriation. Other benefits include improved restart performance of the processor-based system, as well as improvement in chipset validation.

In the following detailed description, reference is made to the accompanying drawings, which show by way of illustration specific embodiments in which the invention may be practiced. However, it is to be understood that other embodiments will become apparent to those of ordinary skill in the art upon reading this disclosure. The following detailed description is, therefore, not to be construed in a limiting sense, as the scope of the present invention is defined by the claims.

Reference throughout this specification to “one embodiment” means that a particular feature, structure, or characteristic described herein is included in at least one embodiment of the invention. Multiple references to “one embodiment” in this document are not meant to necessarily refer to a single embodiment, as each reference may refer to a different embodiment. Further, the features, structures, or characteristics described herein as being part of “one embodiment” may be combined in any suitable manner in one or more embodiments.

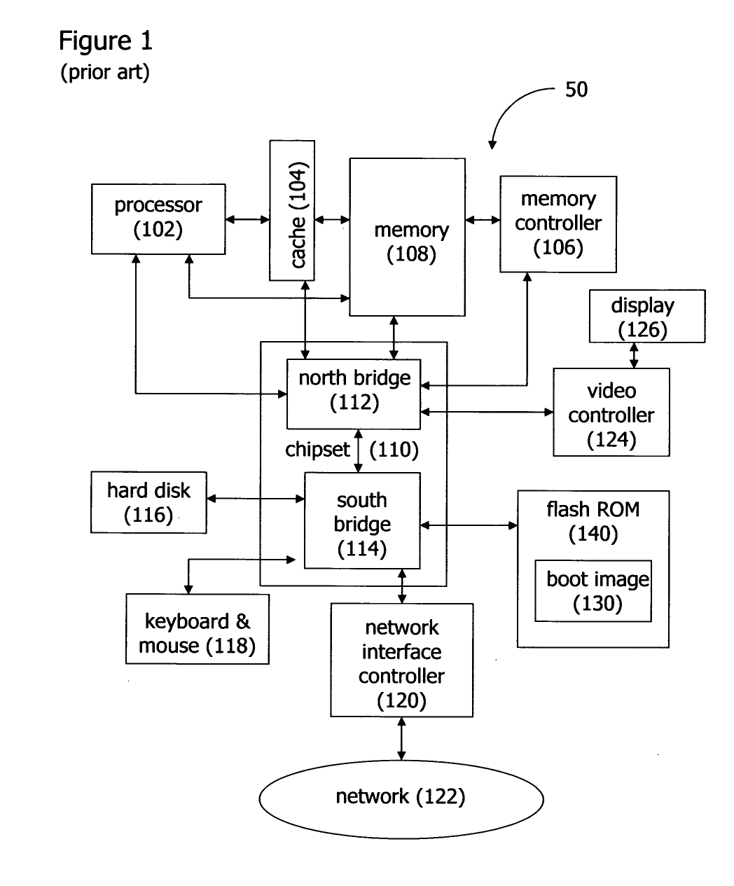

FIG. 1 is a block diagram of a processor-based system 50, according to the prior art. The system 50 includes a processor 102 for executing instructions within the processor-based system, including those found in BIOS firmware, operating system software, hardware drivers, and application programs. The processor 102 is coupled to a memory 108, into which instructions are loaded prior to execution. The memory 108 is controlled by a memory controller 106, which is initialized according to the desired characteristics of the memory. The memory controller 106 may be part of an application-specific integrated circuit (ASIC) or may be a distinct component on the motherboard of the processor-based system.

Between the processor 102 and the memory 108 is a cache 104, which may include separate storage for instructions and data. The cache 104 is a specialized memory for improved performance of the processor-based system. Typically, faster and more expensive static random access memory (SRAM) is used for the cache while slower dynamic RAM (DRAM) is used for the memory. The cache 104 is a location at which frequently used data or instructions are stored, so as to improve processing speed. Although the cache 104 of FIG. 1 is shown external to the processor 102, most caches in personal computer class systems today are built directly into the processor silicon.

The processor-based system 50 also includes a chipset 110, which is a specially designed ASIC soldered to the motherboard of the system. The chipset 110 is used to electrically and logically interconnect the various components of the processor-based system, and may include buses, clocks, and other devices not depicted in FIG. 1. The chipset 110 includes a north bridge 112 and a south bridge 114. The north bridge 112, or processor bridge, electrically and logically connects the processor 102, the cache 104, the memory controller 106, and the memory 108, already described, as well as a video controller 124 and display 126.

The south bridge 114, or I/O bridge, is used to electrically and logically interconnect peripheral devices of the processor-based system, as well as to provide a path between the peripheral devices and the processor 102 and memory 106. The south bridge 114 is shown coupling a hard disk drive 116, such as an intelligent drive interface (IDE) drive, a small computer systems interface (SCSI) drive, and so on, a keyboard, mouse, or other input device 118, a flash ROM 140, and a network interface controller 120. The south bridge 114 may include a peripheral component interconnect, or PCI, bus, an X-bus, or other bus logic not depicted in FIG. 1. Or, the processor-based system 50 may be based on point-to-point interconnects between system components. The north bridge 112 and south bridge 114 components of the chipset 110 are merely representative of typical chipset configurations within processor-based systems.

The NIC 120 couples the processor-based system 50 to a network 122, such as the World Wide Web, a proprietary inter-office network, or other networking environment. Data in the form of packets (not shown) is received by the NIC 120 and sent “upstream,” generally to the memory 108 for further processing by the entity that requested the packets, such as the operating system or application program.

Also connected to the south bridge 114, the flash ROM 140 includes a boot image 130. The flash ROM 140 is programmable non-volatile firmware used to store the boot image, which may be the BIOS firmware, described above, or some other firmware used by the processor-based system. The flash ROM 140 is also known as an electrically erasable programmable read-only memory (EEPROM), because it can be repeatedly reprogrammed (up to a point) with new information. The flash ROM 140 typically has 16 Mbytes of storage, but may be any size. The flash ROM 140 replaces the ROM devices of older processor-based systems.

The boot image 130 stored in the flash ROM 140 is a sequence of instructions (code) used to power up, or “boot,” the processor-based system 50. (The two terms, boot image and boot code are used interchangeably throughout this document.) In a typical implementation, the processor 102 begins executing instructions at a “reset vector,” which is a predetermined memory address at which at least a starting portion of the boot image 130 is stored. For example, in some systems, the reset vector is at the top of the memory address space, such as at 0FFFF:0FFF0h in older PC/AT systems. Shortly after power is applied to the processor-based system 50, the processor 102 automatically fetches code starting at the reset vector as the first address retrieved.

The boot code 130 initializes the processor-based system 50, by configuring and testing memory, executing option ROMs, such as may be found on video cards and disk drives, configuring the chipset 110, and so on. (Since the flash ROM 140 is very slow, the boot code 130 usually copies itself to faster memory as soon as the memory is initialized, then jumps to execute from the memory.) Once the boot code completes its execution, control is passed to the operating system loaded on the processor-based system 50, if present.

The flash ROM is typically a removable chip that inserts into a receiving socket soldered onto the motherboard of the processor-based system. In the field, the flash ROM can be replaced by popping the device out of the socket and replacing it with a new flash device (physical replacement). In other configurations, the flash ROM is permanently soldered to the motherboard of the processor-based system, making physical replacement more difficult. In cases where the boot code programmed into the flash ROM includes an uncorruptable “boot block,” it may be possible to reprogram the non-boot block portion of the boot code from the processor-based system in which the device resides (virtual replacement), that is, by executing flash programming software on the system whose image is to be replaced. The boot block includes just enough boot code to enable the flash reprogramming application to be loaded and executed. Virtual replacement, however convenient relative to physical replacement, is not available where the boot block needs updating. In other configurations, the flash ROM may be reprogrammed with new boot code that has been retrieved from across the network.

The flash ROM in legacy processor-based systems, such as the processor-based system 50 of FIG. 1, typically operates at 8 MBytes/second, which is the same speed at which the ROM device ran when PC/AT systems were first introduced. Thus, relative to other components of processor-based systems, in which twenty years or more of improvements have been made, the flash ROM 140 continues to be a very poor performer. Also, the boot code 130 is “far” from the processor 102, typically down several bus interconnections therefrom. Thus, at least during the initial execution from the flash ROM 140, the boot code 130 runs very slowly.

Further, in today's processor-based systems, the boot code 130 has additional complexity not previously known, including proprietary chipset configuration and intricate memory initialization. Typically, the boot code, such as the BIOS firmware, is modified with each new chipset under development. Proprietary programming of the chipset may improve the speed of memory, lower the power consumed by the system, and so on. BIOS programmers know the intricate electrical and logical design of the chipset, which is also proprietary. Thus, the boot code stored in the flash ROM, as well as the chipset initialization contained in the boot code, are vulnerable to corruption as well as misappropriation.

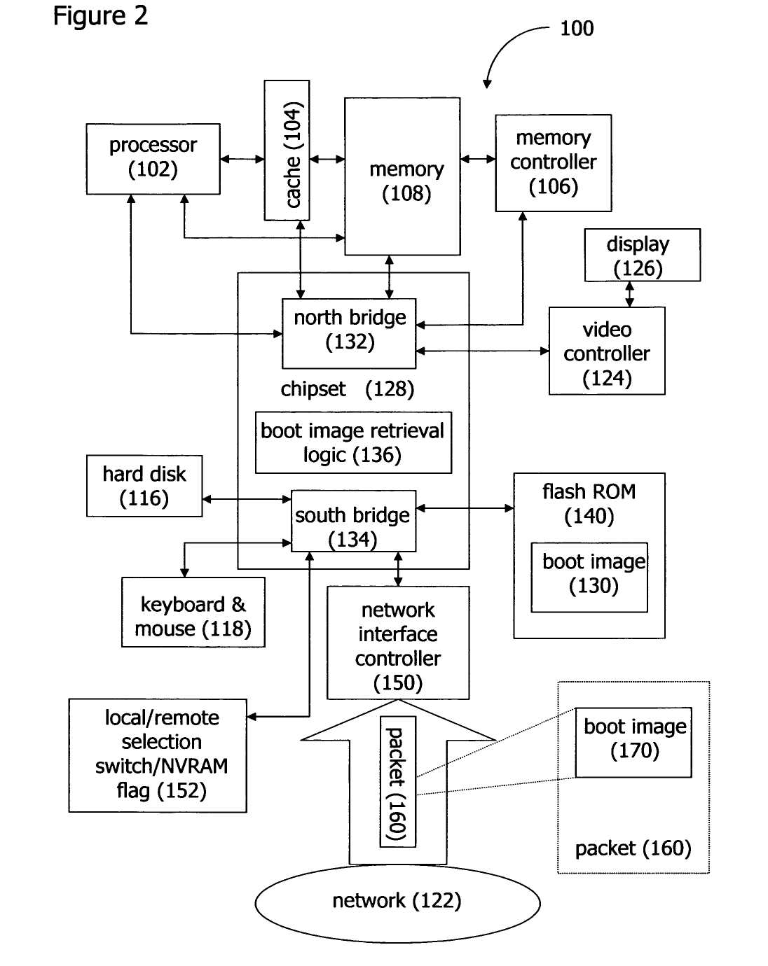

These many issues are overcome using the processor-based system 100 of FIG. 2, which includes hardware for an improved restart, according to one embodiment. The NIC 120 of FIG. 1 has been replaced by a NIC 150. The NIC 150 is receiving a packet 160 from the network 122. The chipset 110 has been replaced with a chipset 128, including a north bridge 132, a south bridge 134, and boot image retrieval logic 136. The boot image retrieval logic 136 and the NIC 150 together perform the operations for an improved restart of the processor-based system 100.

Recently, research has been conducted on ways to improve the performance of packets transmitted over a network. Two protocols, an Internet Protocol (IP) and a Transmission Control Protocol (TCP), are used to route packets across networks, and are commonly referred to in combination (TCP/IP). The TCP/IP stack has not been changed since the inception of personal computers. In legacy systems, the packets processed under the TCP/IP protocol may be stored in memory several times (e.g., in the NIC buffer, the OS buffer, and driver buffer) before being used by the requesting entity.

Techniques for improving on this protocol include one known as direct cache access (DCA). DCA allows the network interface controller (NIC) to place the packet header and descriptor information directly into a processor cache, making it immediately available to the processor, and eliminating the multiple writes to and reads from system memory.

The NIC 150 of FIG. 2 is DCA-capable. Thus, upon receiving the packet 160 from across the network 122, the NIC 150 places the packet 160 directly into the processor cache 104. As will be shown, the NIC 150 receives packets 160, including a boot image 170, such as BIOS firmware, from a remote location on the network 122, for enabling a restart of the processor-based system 100.

According to the DCA protocol, upon receiving the packet 160, the NIC 150 places the packet 160 directly into the cache 104, bypassing the multiple copying of the packet into a NIC buffer, OS buffer, and application buffer (each of which may be allocated portions of the memory 108) under the legacy TCP/IP protocol. By copying the packet 160 directly into the processor cache 104, processing of the packet by the processor 102 may begin immediately.

The boot image retrieval logic 136, part of the chipset, may be discrete logic (hardware) or firmware. The boot image retrieval logic 136 enables the processor 102 and the NIC 150 to communicate with one another during the fetch of the boot image 170 from across the network 122. In addition to notifying the NIC 150 about where to find the boot image 170 on the network 122, the boot image retrieval logic 136 also performs the authentication of the boot image 170 prior to its execution.

The processor-based system 100 includes the boot image 130 (local boot image) shown in FIG. 1. Additionally, the packet 160 is shown with a second boot image 170 (remote boot image). As will be shown, the remote boot image may be used to replace a local boot image, such as to fix a corrupted local boot image, to fix a chipset configuration problem, to improve performance of the processor-based system 100, to provide an alternative configuration of the processor-based system, to build a cheaper processor-based system (minus the flash memory part), or to facilitate testing of the processor-based system.

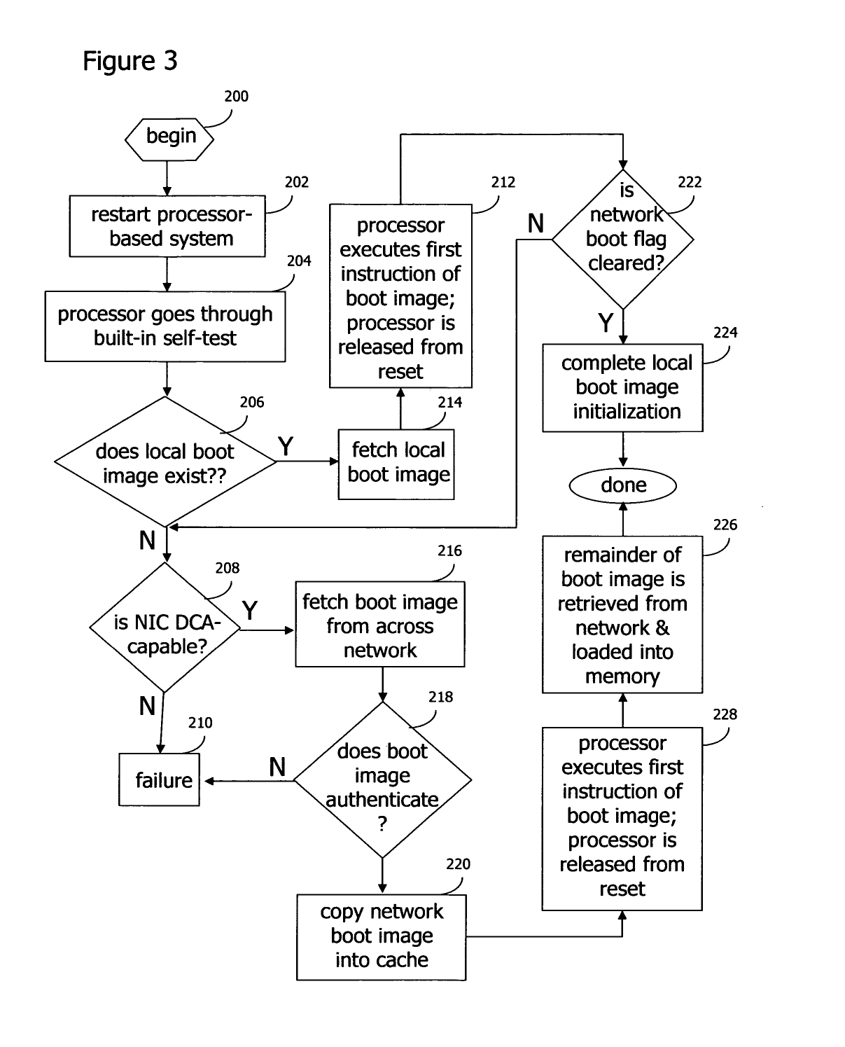

FIG. 3 is a flow diagram 200 of the process flow for restarting the processor-based system 100 using the boot image 170 retrieved from the network 122, according to one embodiment. The process begins with a restart of the processor-based system 100 (block 202). The restart may be a “cold boot,” in which the processor-based system 100 transitions from having no power (turned off) to receiving power, such as when a user pushes an “ON” button on the chassis of the processor-based system. Or, the restart may be a “warm boot,” in which the processor-based system 100 was previously in a fully operational state (such as with operating system and application software running), and subsequently transitioned to an initialization state, without any disruption in power having been made. The “warm boot” may have been application- or operating system-initiated, such as following a new configuration, or user-initiated, such as by issuance of a CTRL-ALT-DEL keystroke sequence in response to a system hang. Whatever the circumstance, upon restart of the processor-based system 100, the processor 102 performs a built-in self-test (BIST) (block 204). The BIST enables the processor 102 to internally generate a sequence of test voltages to verify its functionality prior to executing code, and may further include internal register and other initialization.

The boot image retrieval logic 136 of the chipset 128 next determines whether any local boot image exists in the processor-based system 100 (block 206). The local boot image may be stored in a read-only memory (ROM), erasable programmable ROM (EPROM), electrically erasable PROM (EEPROM), or a flash device, such as the boot image 130 in the flash ROM 140 (FIG. 2). Or, the local boot image may be stored in other non-volatile media, such as on a dedicated partition of a disk drive, as is disclosed in U.S. patent application Ser. No. 10/746,754. If the local boot image does not exist, the chipset 128 next determines whether the NIC is DCA-capable (block 208). If not, the system has no mechanism for booting, thus, system failure occurs (block 210).

Where the boot image retrieval logic 136 instead determines that local boot code does exist (the “yes” prong of block 206), the logic 136 fetches the local boot image (block 214), such as the boot image 130. The processor 102 executes the first instruction of the boot image, at which point the processor is released from reset (block 212). (The boot image may have a checksum or other means by which the boot image retrieval logic 136 can check its integrity before execution of its instructions.)

Where the processor-based system 100 includes both local boot code (boot image 130) and remote boot code (boot image 170), the system can use the latter if the former is deficient. In some circumstances, this may be determined only after the local boot code has begun executing. One mechanism for ascertaining the quality of the local boot code is to set a flag once the local boot code has successfully executed a predetermined portion of the local boot code. The predetermined portion may be the completion of the memory initialization, or some other portion deemed critical by the system designer. In one embodiment, the processor-based system 100 includes a “network boot” flag, which is cleared after the memory initialization has successfully completed.

If the boot image retrieval logic 136 determines that the “network boot” flag has not been cleared (the “no” prong of block 222), this means that either the local boot image is corrupt (i.e., code to clear the flag was not executed) or the memory initialization failed to complete. If the latter occurs, the BIOS cannot be loaded into memory for execution.

If neither of these failure conditions exists, the initialization from the local boot code, such as the boot image 130, continues, as is customary in legacy processor-based systems (block 224). In addition to initializing and testing memory, the local boot image may perform chipset initialization and execute option ROMs. Once the local boot code completes its initialization, control is passed to the operating system loaded on the processor-based system, if present.

Where, instead, either of the failure conditions exist (memory bad or local boot image bad), the boot image retrieval logic 136 determines whether the NIC is DCA-capable (block 208), as is the NIC 150 in FIG. 2. If so, the processor 102 and NIC 150 communicate with one another to fetch the boot image from across the network 122, with the assistance of the boot image retrieval logic 136 (block 216). The boot image retrieval logic 136 may include instructions for identifying the correct boot image, including its location on the network, and may communicate these instructions to the NIC 150 in many different ways. The boot image 170 is received by the NIC 150 in the form of packets 160. At this point, according to the DCA protocol, the packets 160 are loaded into the processor cache 104.

Unlike for the local boot image, the source of the remote boot image being received across the network 122 is uncertain. Thus, instructions are executed by the boot image retrieval logic 136 to authenticate the boot image 170 (block 218). The authentication may be conducted using any of a number of authentication protocols, such as Public Key Infrastructure (PKI). If the authentication fails, the processor-based system 100 is unable to boot (block 210). If the authentication succeeds, the boot image 170 is loaded, packet by packet, into the processor cache 104 and the processor 102 is released from reset (block 228). Since the boot code 170 is likely to be larger than the cache 104, at least a portion of the memory 108 is initialized so that additional packets 160 of the boot image 170 may be retrieved from across the network 122 and loaded into the memory (block 226). The process of booting the processor-based system 100 is thus complete.

By having both local boot code (boot image 130) and access to remote boot code (boot image 170) available to the processor-based system 100, improved flexibility of the processor-based system 100 may be realized. For example, by setting an optional user-accessible switch, shown as a local/remote selection switch 152 in FIG. 2, the processor-based system may be restarted using the local boot code in one instance, and using the remote boot code in a second instance. As another possibility, the local/remote selection switch 152 may be a flag located in non-volatile RAM (NVRAM). In this way, the remote boot code can be retrieved and executed without the processor-based system having a corrupted local boot problem.

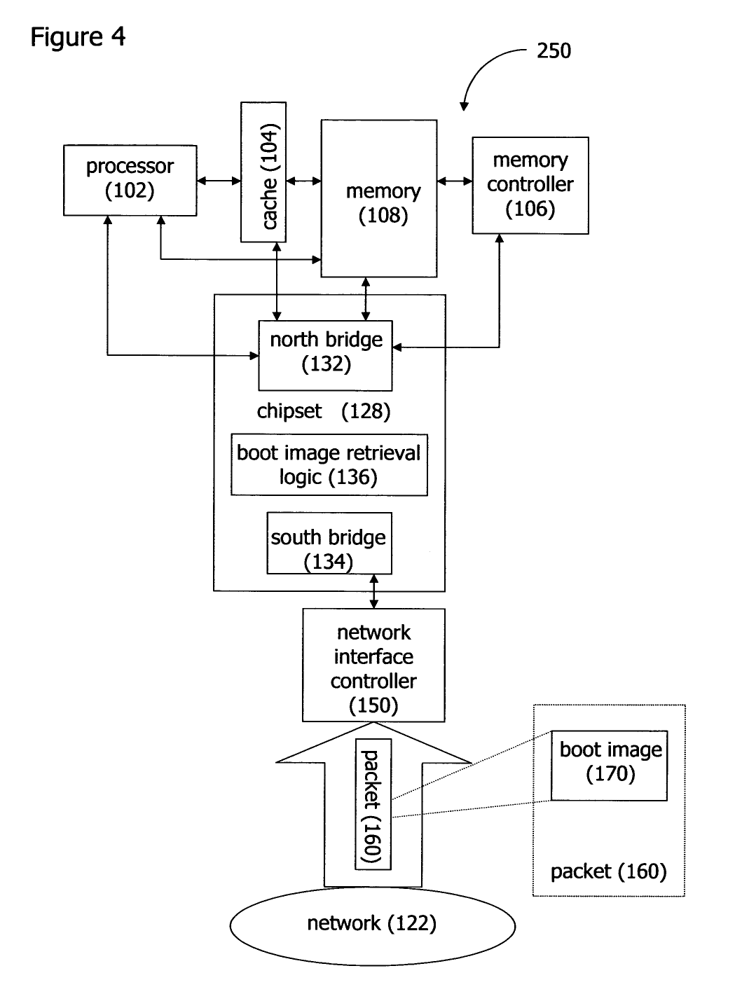

In FIG. 4, a block diagram of another processor-based system 250 is depicted, according to some embodiments. In this system, there is no hard disk, no input device, such as a keyboard or mouse, no video controller or display, and no flash ROM for storing a local boot image. The system 250 does, however, include the DCA-capable NIC 150 and the chipset 128, including the boot image retrieval logic 136. Systems such as the processor-based system 250 are becoming common in some environments, such as in server configurations.

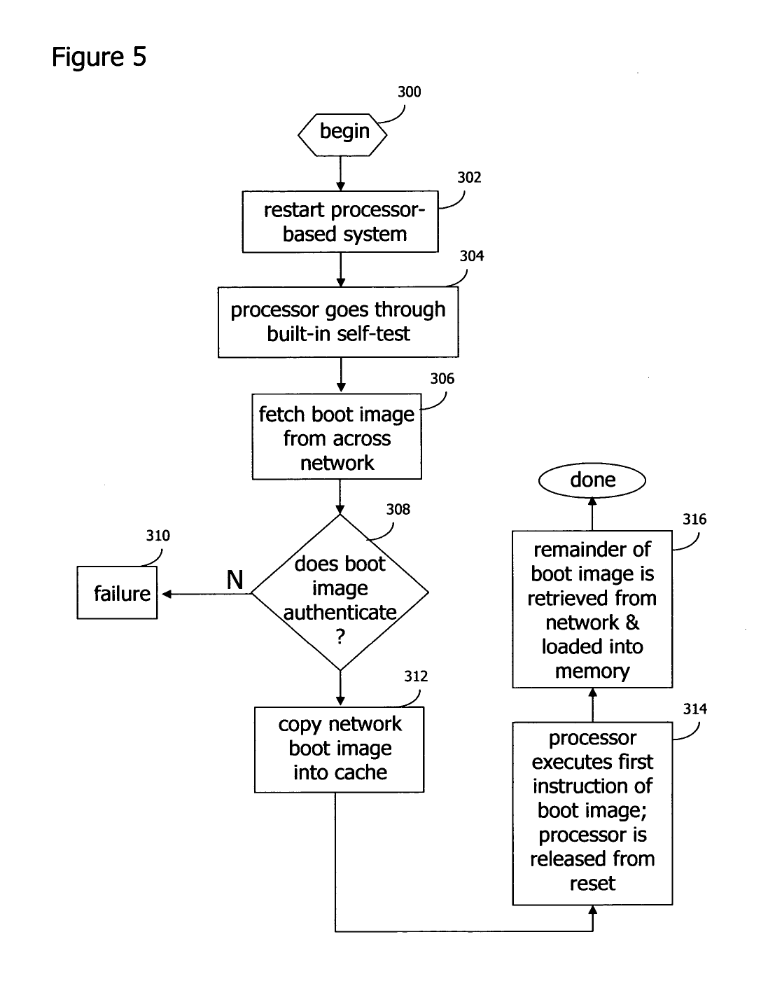

In the flow diagram 300 of FIG. 5, several process steps have been eliminated from the flow diagram 200 (FIG. 3), to remotely start the processor-based system 250 of FIG. 4. Following restart (block 302) and the processor BIST (block 304), the boot image is immediately fetched from across the network (block 306), authenticated (block 308), and copied into the processor cache (block 312). The processor then executes the boot code and retrieves the remainder of the boot image from across the network (blocks 314 and 316).

The technique demonstrated in FIG. 5 may be preferred for some computing environments, such as for server systems. The elimination of the flash memory on the processor-based system 250 represents cost savings. Further, the absence of a resident boot image mitigates the likelihood that malicious software, or “malware,” will surreptitiously or openly discover the intellectual property of the BIOS firmware or the chipset programmed by the BIOS firmware. Also, with the enhanced throughput offered by DCA, restarting the processor-based system 250 using the remote boot code may improve the power-on performance of the system.

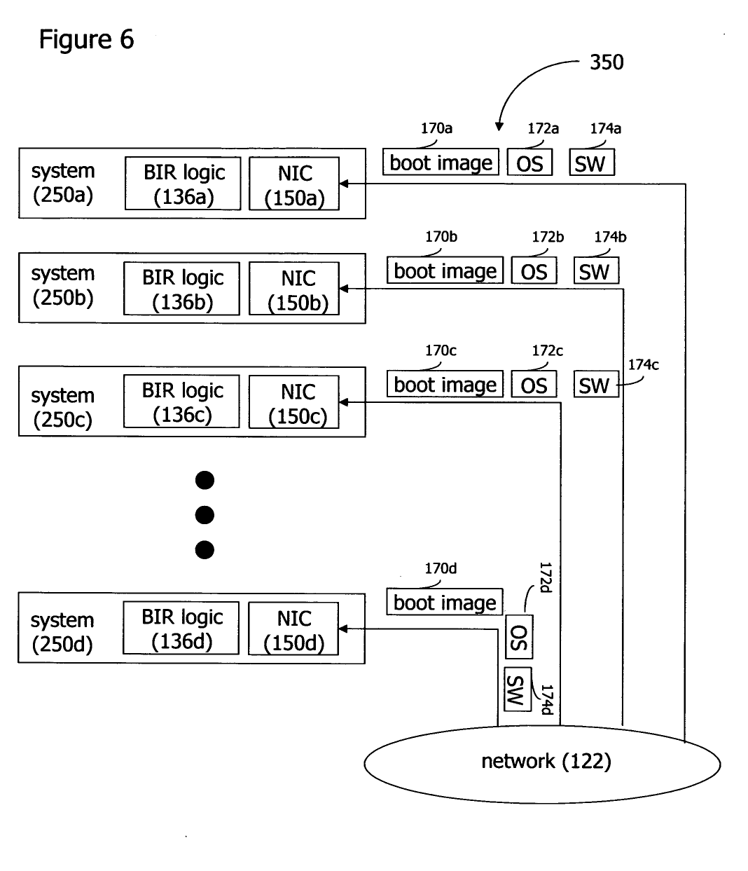

In FIG. 6, a block diagram of a processor-based system 350 is depicted, according to one embodiment. The processor-based system 350 is a collection of processor-based systems 250a, 250b, 250c, . . . 250d, like the system 250 depicted in FIG. 4, upon which very few peripheral devices reside, but each of which include a reliable network interface 150a, 150b, 150c, . . . 150d, and boot image retrieval (BIR) logic 136a, 136b, 136c, . . . 136d, respectively. Again, the system 350 includes DCA-capable NICs, for retrieving the remote boot image to local storage for fast execution.

In the processor-based system 350, each processor may boot using a different remote boot image, remote operating system, and remote application program, as shown. For example, boot image 170c, operating system 172c, and software 174c are loaded to the processor-based system 250d using the DCA-capable NIC 150c and boot image retrieval logic 136c; boot image 170a, operating system 172a, and software 174a are loaded to the processor-based system 250a using the DCA-capable NIC 150a and boot image retrieval logic 136a.

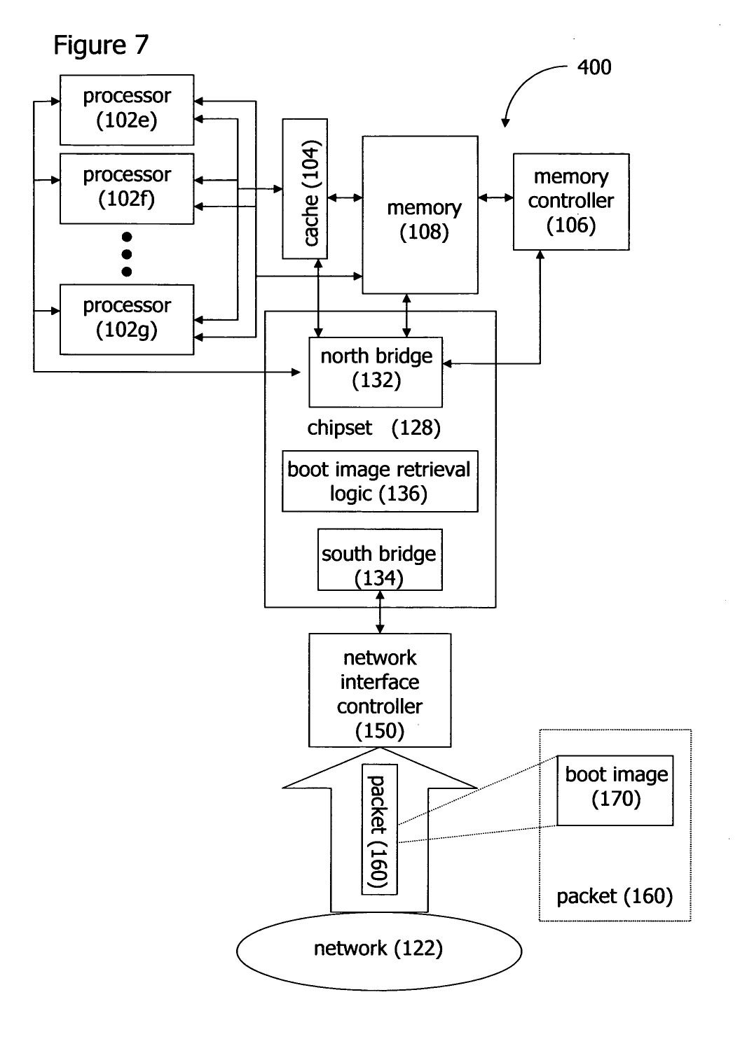

In FIG. 7, a processor-based system 400 is depicted, in contrast to the processor-based system 350 of FIG. 6, in which multiple processors (102e, 102f, and 102g) share a single memory 108 and chipset 128, including the boot image retrieval logic 136. In such a configuration, one of the processors is designated as the “boot” processor. Again, the NIC 150 is DCA-capable. Remote boot code is retrieved from the network 122, loaded into the processor cache, and executed by the designated boot processor.

Any of the processor-based systems 100, 250, 350, or 400 can benefit from the network-based restart described herein. In addition to providing a network-based update to corrupted local boot code, which may be helpful in the field, the network-based restart enables a faster restart over the local boot-based restart, in one embodiment, since the boot code resides in the fast cache. The network-based restart may also facilitate testing of new chipset firmware, as new versions of BIOS code may be downloaded without removing the flash ROM from the motherboard, which may result in a faster time to market for the chipset under development. Systems using network-based restart may also be protected from the misappropriation of the BIOS firmware, as well as the intellectual property of the chipset.

The network-based restart described herein may be used in conjunction with an Extensible Firmware Interface, or EFI. EFI is a public industry specification that describes an abstract programmatic interface between platform firmware and shrink-wrap operation systems or other custom application environments. (The Extensible Firmware Interface Specification, version 1.10, Nov. 26, 2003, is available from Intel Corporation of Santa Clara, Calif.) The EFI framework includes provisions for extending firmware functionality beyond that provided by the BIOS code stored in the flash memory. More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and over computer networks.

While the invention has been described with respect to a limited number of embodiments, those skilled in the art will appreciate numerous modifications and variations therefrom. It is intended that the appended claims cover all such modifications and variations as fall within the true spirit and scope of the invention.

We claim:

1. A system, comprising:
a processor to execute instructions;
a memory and a cache to store the instructions;
a network interface controller to couple to a network, wherein the network interface controller receives a packet from the network and stores the packet in the cache; and
a chipset, wherein the chipset instructs the network interface controller to retrieve a remote boot image from the network in at least one of the following cases:
where no local boot image exists;
where the local boot image is corrupt; or
where the local boot image executes but fails to complete within a predetermined time period.

2. The system of claim 1, wherein the network interface controller is direct cache access capable.

3. The system of claim 1, wherein at least part of the remote boot image is executed from the cache.

4. The system of claim 1, further comprising:
a flash memory, wherein the flash memory stores the local boot image, if present.

5. The system of claim 4, further comprising:
a local boot image programmed into the flash memory.

6. The system of claim 5, further comprising:
a user-accessible two-state switch to indicate whether the local boot image or the remote boot image are to be executed, wherein the local boot image is executed when the switch is in a first state and the remote boot image is executed when the switch is in a second state.

7. The system of claim 5, further comprising:
a two-state flag stored in a non-volatile memory to indicate whether the local boot image or the remote boot image is to be executed.

8. The system of claim 1, further comprising:
instructions to authenticate the remote boot image before execution.

9. A method, comprising:
performing a built-in-self test by a processor, the processor residing in a system;
retrieving a remote boot image by a network interface controller coupling the system to a network, the network interface controller having direct cache access capability, wherein the remote boot image is stored in a cache of the system once retrieved; and
executing the remote boot image from the cache.

10. The method of claim 9, further comprising:
identifying a problem with a local boot image of the system.

11. The method of claim 10, identifying a problem with the local boot image of the system further comprising:
determining that the local boot image is not present.

12. The method of claim 10, identifying a problem with the local boot image of the system further comprising:
determining that the local boot image is corrupt.

13. The method of claim 10, identifying a problem with the local boot image of the system further comprising:
executing the local boot image; and
determining that the local boot image is unable to complete execution.

14. The method of claim 9, further comprising:
reading a switch, the switch being a selector between a local boot image and the remote boot image; and
executing one of the boot images based on the switch value.

15. A system, comprising:
a network interface controller to couple a processor in the system to a network, wherein the network interface controller is direct cache access-capable; and
a cache coupled to the processor, wherein the cache stores instructions and data, the cache operating at a speed faster than a memory;
wherein the network interface controller retrieves a boot image from the network, stores the boot image in the cache, and the processor executes at least part of the boot image during power-on of the system.

16. The system of claim 15, wherein the boot image is authenticated prior to being executed.

17. An article comprising a medium storing instructions to enable a processor-based system to:
perform a built-in-self test by a processor, the processor residing in a system;
retrieve a remote boot image by a network interface controller coupling the system to a network, the network interface controller having direct cache access capability, wherein the remote boot image is stored in a cache of the system once retrieved; and
execute the remote boot image from the cache.

18. The article of claim 17, further comprising a medium storing instructions to enable a processor-based system to:
identify a problem with a local boot image of the processor-based system.

19. The article of claim 17, further comprising a medium storing instructions to enable a processor-based system to:
read a switch, the switch being a selector between a local boot image and the remote boot image; and
execute one of the boot images based on the switch value.

20. The article of claim 17, further comprising a medium storing instructions to enable a processor-based system to:
authenticate the remote boot image prior to its execution.
